(19) United States
(12) Patent Application Publication
(10) Pub. No.: US 2008/0185196 A1
(43) Pub. Date: Aug. 7, 2008

(54) Electrically Propelled Vehicle

(76) Inventor: Romano Artioli, Luxembourg (LU)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/916,879

(22) PCT Filed: Jun. 5, 2006
(86) PCT No.: PCT/IB2006/001453

§ 371 Date: Dec. 7, 2007

(30) Foreign Application Priority Data
Jun. 7, 2005 (IT) MI2005A001055

(51) Int. Cl. B60K 6/22; G06F 19/00

(52) U.S. Cl. 180/65.2; 701/22; 903/940

(57) ABSTRACT

A propulsion apparatus for a vehicle comprising an electric motor for rotationally actuating at least one driving wheel of the vehicle; a power source comprising a storage battery for supplying a current to the electric motor; an internal-combustion engine operationally connected to a reversible electric machine; the reversible electric machine being electrically connected to the electric motor and/or to the storage battery so as to supply the current to the electric motor and/or recharge the storage battery, respectively, wherein it does not have a movement transmission for connecting the internal-combustion engine to the driving wheel of the vehicle.

The present invention relates to an electrically propelled vehicle and to a propulsion apparatus for a vehicle, in accordance with the preamble of Claim 1.

Nowadays the vast majority of motor vehicles on the road use internal-combustion (or “endothermic”) engines as the main engine.

However, owing to numerous factors including those of an environmental and economic nature, these types of motor vehicles are becoming increasingly unacceptable.

As an alternative to motor vehicles equipped with internal-combustion engines, electric motor vehicles, namely motor vehicles which use a storage battery as the sole energy source, have enjoyed a certain success.

Electric motor vehicles are more acceptable from both an environmental and an economic point of view.

However, despite extensive experiments in this sector, motor vehicles which are able to provide the same operating characteristics ensured by motor vehicles equipped with internal-combustion engines have not yet been developed. In particular, these electric motor vehicles have a limited autonomy.

By way of a compromise solution, recently so-called hybrid motor vehicles, namely motor vehicles with a hybrid propulsion system, have been favoured by the motor car industry and users.

Usually such a hybrid propulsion system comprises:
a storage battery;
a so-called drive motor, consisting of a conventional direct-current electric motor, for actuating the driving wheels of the motor vehicle;
an internal-combustion engine mechanically connected via transmission means to the driving wheels of the motor vehicle;
a permanent-magnet current motor mechanically connected rotationally to the internal-combustion engine;
control means which are able to detect the charged state of the storage battery.

During operation using the storage battery, the internal-combustion engine is switched off and disengaged from the driving wheels and the movement of the vehicle is ensured by the electric motor powered by the said storage battery.

When the control means detect that the voltage at the terminals of the storage battery is below a predefined voltage level, they deviate the current to the generator which thus, being mechanically connected rotationally to the permanent-magnet motor, acts as a starter motor for the latter.

Following start-up of the internal-combustion engine, the latter causes rotation of the permanent-magnet motor so that the latter acts as a generator of an electric current which powers the electric motor so as to ensure the movement of the motor vehicle.

Any surplus current generated by the permanent-magnet motor with respect to the actual consumption of the electric motor is used for the operation of recharging the storage battery.

As soon as the voltage at the terminals of the storage battery has reached again the rated voltage value, the control means automatically switch off the internal-combustion engine and the motor vehicle starts to function again normally powered by the storage battery, as described above.

During operation with the internal-combustion engine, or when the motor vehicle is operating under particularly severe conditions, for example during sudden acceleration, the movement of the motor vehicle is ensured simultaneously by the electric motor and the internal-combustion engine.

Despite the undeniable advantages from a constructional and operational point of view, this known propulsion system has the undoubted disadvantage consisting in the fact that the internal-combustion engine is mechanically connected to the driving wheels. This involves the need to design chassis which are able to house the transmission means, resulting in less efficient use of the passenger space or less comfort for the occupants of the motor vehicle.

A further disadvantage and undesirable aspect of such a propulsion system is that it has excessively large dimensions and is bulky since the motor vehicle must be equipped with two propulsion units and their respective transmissions. In particular, in order to provide the driving wheels with a predetermined power, the entire propulsion system must be dimensionally designed so that it has a total power equal to about twice that required by the single motor.

In view of the state of the art described, the object of the present invention is to provide a hybrid propulsion apparatus which is highly efficient and does not have the abovementioned drawbacks.

More particularly, the object of the invention is to provide a vehicle which is particularly simple and low-cost and at the same time able to allow a practical and versatile use of the vehicle, having sufficient autonomy and without the need for envisaging an excessively large total power of the propulsion apparatus.

Another object of the invention is to provide a vehicle having a compact hybrid propulsion apparatus which has a low consumption and causes a very limited amount of pollution and which also comprises a particularly small number of substantially simple and reliable components.

In accordance with the present invention, this object is achieved by means of a hybrid propulsion apparatus for a vehicle, a vehicle thus operated and a method for controlling the propulsion of a vehicle in accordance with the characterizing part of Claims 1, 15 and 22.

The characteristic features and advantages of the present invention will become clear from the following detailed description of a practical embodiment illustrated by way of a non-limiting example in the accompanying drawings in which:

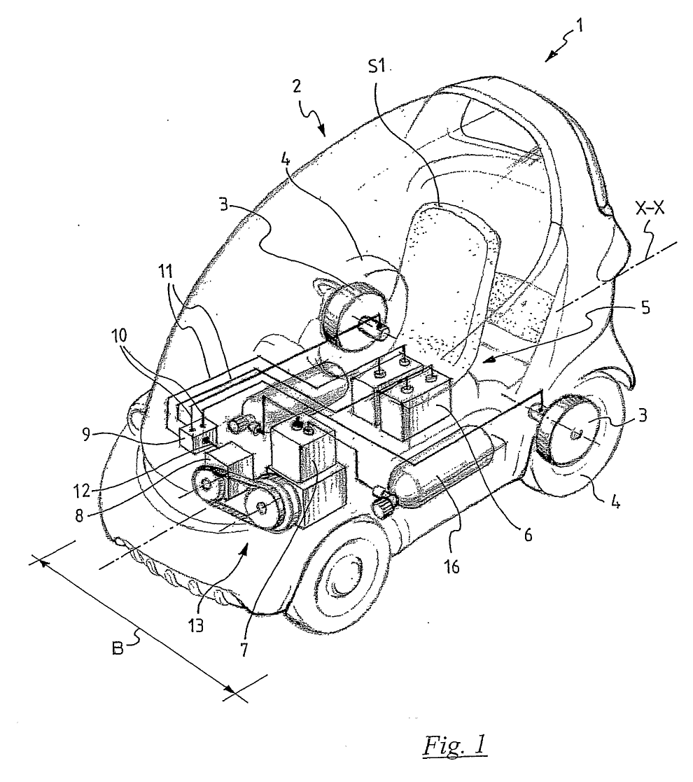

FIG. 1 shows a schematic perspective view of a vehicle equipped with the propulsion apparatus according to the present invention;

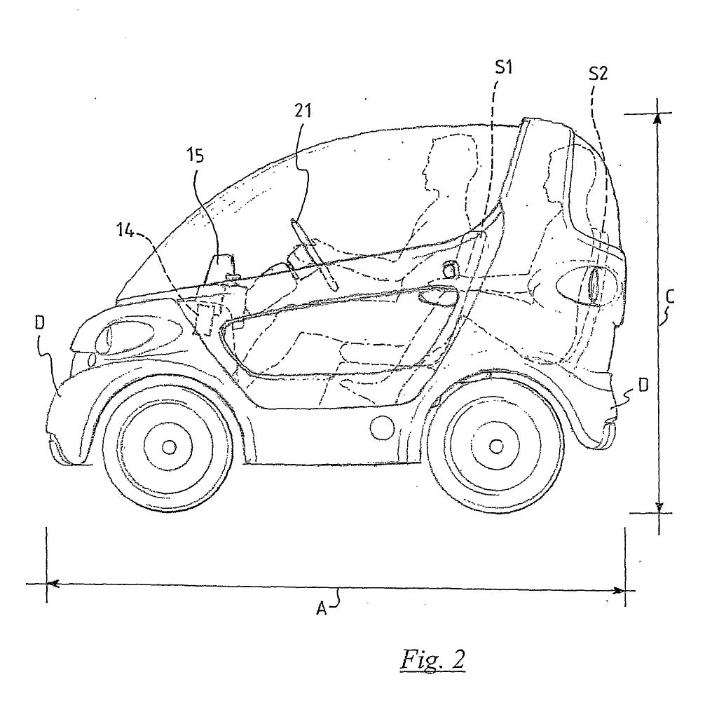

FIG. 2 shows a side view of the vehicle in FIG. 1 according to the present invention;

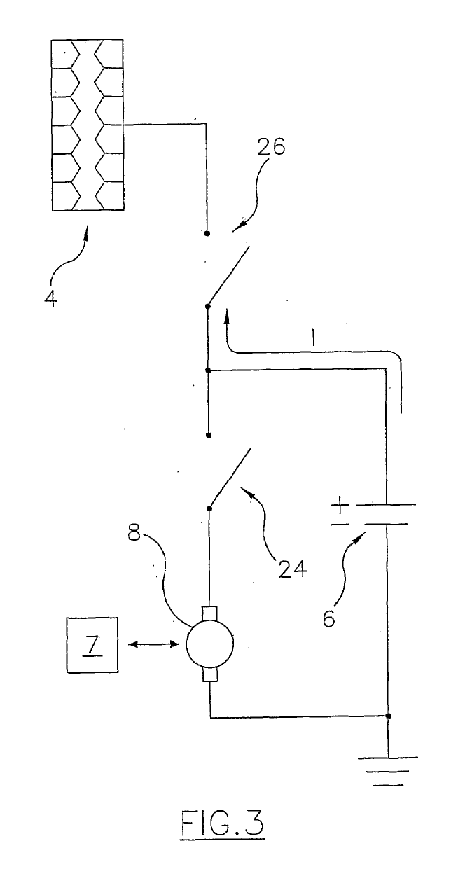

FIG. 3 shows a simplified circuit diagram of the propulsion apparatus for the vehicle according to the present invention.

With reference to the accompanying figures, 1 denotes overall a hybrid propulsion apparatus for a vehicle 2 according to the invention.

The inventive propulsion apparatus 1 comprises:
an electric motor 3 for rotationally actuating at least one driving wheel 4 of said vehicle 2;
a power source 5 comprising a storage battery 6 for supplying a current I to said electric motor 3;
an internal-combustion engine 7 operationally connected to a reversible electric machine 8;
said reversible electric machine 8 is electrically connected to said electric motor 3 and to said storage battery 6 so as to supply said current I to said electric motor 3 and/or recharge said storage battery 6, respectively.

Advantageously, the inventive propulsion apparatus 1 does not have movement transmission members for connecting the internal-combustion engine 7 to the driving wheel 4 of said vehicle 2.

In the example shown, the vehicle 2 may have a small-size passenger compartment; in practice with maximum longitudinal dimensions A in the region of 200 cm, with transverse dimensions B of about 100 cm and with a height C in the region of 150 cm.

The passenger compartment in the embodiment shown in FIG. 2 is able to receive two seats S1 and S2 for two users, which are arranged in tandem with positioning which corresponds substantially to that of the two passengers on a motor cycle or equivalent vehicle; the seat S1 may be folded down forwards so as to facilitate access for the passenger who must sit on the rear seat S2.

The chassis of the vehicle 2 is equipped with suitable bumpers of the shock-absorbing type D or other equivalent and known type.

Advantageously, the propulsion apparatus 1 comprises control means 9 for electrically and selectively connecting said storage battery 6 to said electric motor and/or to said reversible electric machine 8.

Principally, the control means 9, which preferably take the physical form of an ECU, are provided with a power supply output 10 connected to the electric motor 3 and a two-way connection 11 with the storage battery 6 and a two-way connection 12 with the reversible electric machine 8.

The latter, as will become clearer below, may be of any type suitable for the purpose and may also comprise, for example, a dynamotor.

In any case the reversible electric machine 8 is rotationally connected to the shaft of the internal-combustion engine 7 by means of movement transmission means 13.

These movement transmission means 13 in a preferred embodiment of the present invention take the physical form of a continuous variation transmission (CVT).

As will be better clarified below, the reversible electric machine 8 is able to be selectively powered by the storage battery 6 via the control means 9 and the two-way connection 12 so as to rotate at a first speed of rotation below a first threshold so as to start the internal-combustion engine 7.

According to one aspect of the invention, after start-up of the internal-combustion engine 7 the latter in turn causes rotation of the reversible electric machine 8, preferably in the same direction, at a second speed of rotation which is higher than said first threshold. When the reversible electric machine 8 exceeds the first threshold speed, it behaves like a generator, producing electric energy able to power the electric motor 3 so as to actuate rotationally the driving wheel 4 of said vehicle 2.

By way of a preferred example, the reversible electric machine 8 is a permanent-magnet motor with a 72V power supply and power output of 2.5 kW, while the internal-combustion engine 7 is able to operate at a running speed where it has maximum efficiency, driving the reversible electric machine 8, with a suitable transmission ratio determined by the continuous variation transmission, at a predefined speed of rotation.

Advantageously, the propulsion apparatus comprises furthermore circuit means 14 which are able to transfer the voltage value detected by the control means 9 to display means 15. In particular, these display means take the physical form of an analog or liquid crystal display able to constantly inform the user as to the charged state of the storage battery as well as other parameters such as the speed, average and momentary consumption, etc.

With reference to FIG. 2, 21 denotes the steering wheel, positioned so as to be comfortably accessible for the passenger sitting in the front seat S1 of the pair of seats arranged in tandem.

The internal-combustion engine 7 may be an Otto engine, Diesel engine or engine powered by any fuel chosen from the group comprising petrol, methane, biofuel, GPL and diesel.

In a preferred embodiment the internal-combustion engine 7 is a two-stroke direct-injection engine powered by natural gas, such as, for example, methane.

It is thus the case that preferably the internal-combustion engine 7 is powered by methane, said methane being contained in special tanks 16.

Advantageously, the tanks 16 are arranged so as to be aligned in a predefined longitudinal direction X-X of the vehicle 2 in which the vehicle 2 extends from the front end to the rear end with reference to the direction of forward rectilinear travel of the said vehicle.

It should be noted that the storage battery 6 is preferably housed inside a box-shaped container 17 associated with the chassis of the vehicle 2 and positioned underneath the seats S1 and S2.

In accordance with the present invention said at least one driving wheel 4 is a rear driving wheel of the vehicle 2. In a preferred embodiment of the present invention the vehicle 2 comprises two rear driving wheels. Alternatively it is envisaged that the vehicle 2 may be driven by all four driving wheels.

Advantageously the electric motor 3 is housed or incorporated inside each of the driving wheels 4 of the vehicle 2.

The driving wheels 4 are therefore each equipped with a motor as mentioned above, so that the mechanical transmissions and in particular the differential for operation of the wheels are eliminated.

Alternatively, it is envisaged that the electric motors 3 may be housed inside the chassis of the vehicle 2.

In a different embodiment of the present invention (not shown in the accompanying drawings) the power source 5 may comprise a photovoltaic panel which can be electrically connected to the electric motor 3 and/or to said storage battery 6.

According to another aspect of the invention, the control means 9 are able to detect the charged state of the storage battery 6 and are designed to operate automatically the reversible machine 8 as described above, when the voltage detected at the terminals of the storage battery 6 falls below a predefined threshold voltage value, so as to start up the internal-combustion engine 7.

During operation, the control means 9 are able to keep the internal-combustion engine 7 normally switched off and connect the storage battery 6 in order to power the electric motor 3 so as to drive rotationally the driving wheels 4 of the vehicle 2 which therefore behaves in the manner of a conventional electric vehicle.

When the charge of the storage battery 6 falls below the predefined threshold value (which value may also be adjusted by the user), the control means 9 detect this condition and use the residual charge of the storage battery 6 to operate the reversible electric machine 8. The latter starts up the internal-combustion engine 7 which in turn (after start-up) drives the reversible electric machine 8 as already described above. The reversible electric machine 8 therefore behaves in the manner of a generator and supplies electric power to the motor 3 by means of the two-way connection 11 and the control means 9.

As already mentioned, the control means 9 are designed to apply to the electric motor 3 the power produced by the generator group 7 and 8 in parallel with the power supply provided by the storage battery 6.

Therefore the following situations may occur:

I°: when the power produced by the generator group 7 and 8 is greater than the electric power used by the electric motor 3 (as occurs under normal operating conditions of the vehicle 2), the surplus power produced is intended to recharge the storage battery 6 which therefore does not require an external source for this purpose. Obviously, the control means 9 are able to interrupt the storage battery charging operation, switching off the internal-combustion engine 7 in the case where the storage battery 6 is charged to a voltage level close to the rated voltage value.

II°: when the energy produced by the generator group 7 and 8 is lower than the electric power used by the electric motor 3 (which situation may occur when the vehicle 2 must overcome a slope), the power of the storage battery 6 is added to that produced by the reversible electric machine 8 so as to provide the electric motor 3 with the necessary power. Basically, the storage battery 6 behaves in the manner of a backup power supply unit. As a result, it is possible to use an internal-combustion engine 7 which has a very limited power—and therefore volume, weight, cost, consumption and emission—for example equal to about 6 kW.

Advantageously, the propulsion apparatus (and therefore also the vehicle 2) does not have movement transmission means for connecting the internal-combustion engine 7 to the driving wheels 4 of the vehicle 2. This allows maximum freedom for designing the position of the internal-combustion engine 7. In particular, the internal-combustion engine 7 may be housed anywhere within the chassis of the vehicle 2 namely in any point where there is sufficient space to receive it.

In accordance with a feature of the present invention, the internal-combustion engine 7 and the storage battery 6 perform a synergic action by means of the control means 9 and the reversible electric machine 8 so as to power the electric motor 3.

In particular, the reversible electric machine 8 may act as a starter device for the internal-combustion engine 7 and a generator able to power the electric motor 3 and recharge the storage battery 6. The latter, in turn, under normal conditions is the only power source for driving the vehicle and, in conditions where a large amount of power is used by the electric motor 3, performs a back-up action, supplying additional power.

This ensures versatile operation and a high degree of autonomy of the vehicle 2, without the need to design the internal-combustion engine 7 with excessively large dimensions. Furthermore, another result is that the cost, volume, weight and energy consumption are reduced considerably. In fact, this solution, which is normally called a hybrid solution, has the great advantage that it is no longer conditioned by the critical problem of having to recharge the batteries, being able to fill up with fuel at a normal methane gas fuelling station (if a methane-gas powered two-stroke engine is chosen as the internal-combustion engine 7).

With reference to FIG. 3, it can be noted that the reversible electric machine 8 is connected to the terminals of the storage battery 6 (for the sake of simplicity of the illustration the control means 9 are not shown here) via a switch 24 operated, for example, by a coil (not shown in the figures).

The positive terminal of the storage battery 6 is connected by means of a main switch 26 to the driving wheel 4 housing the electric motor 3, while the other terminal of the storage battery 6 is connected to earth.

When the user decides to move the vehicle 2 using electric driving power, the switch 26 must be closed.

When the control means 9 detect that the voltage at the terminals of the storage battery 6 is below a predefined voltage level, the switch 24 is also closed.

At this point the reversible electric machine 8 is powered by the storage battery 6 and starts up the internal-combustion engine 7, as described above. After start-up of the internal-combustion engine 7, the latter rotationally drives the reversible electric machine 8, causing it to operate as a generator which powers the electric motor 3 so as to ensure the movement of the motor vehicle 2. Any surplus current generated with respect to the actual consumption of the electric motor 3 is used for the operation of recharging the storage battery 6.

As soon as the voltage at the terminals of the storage battery 6 has reached the rated voltage value, the control means 4 automatically switch off the internal-combustion engine 7 and open the switch 24 and the vehicle starts to operate normally again, powered by the storage battery 6.

During particularly severe operating conditions, for example sudden acceleration, the movement of the vehicle 2 is ensured simultaneously by the electric motor 3 and the reversible machine 8.

It should be noted, moreover, in order to avoid the presence of a current directed from the reversible electric machine 8 to the storage battery 6, advantageously polarisation means, such as, for example, a polarisation diode able to prevent this from happening, are envisaged (not shown in figures).

Obviously, a person skilled in the art, in order to satisfy contingent and specific requirements, may make numerous modifications and variations to the configurations described above, all of which, however, are contained within the scope of protection of the invention as defined by the following claims.

1. A propulsion apparatus for a vehicle comprising:
an electric motor for rotationally actuating at least one driving wheel of said vehicle;
a power source comprising a storage battery for supplying a current to said electric motor;
an internal-combustion engine operationally connected to a reversible electric machine;
said reversible electric machine being electrically connected to said electric motor and/or to said storage battery so as to supply said current to said electric motor and/or recharge said storage battery, respectively;
wherein propulsion apparatus does not have movement transmission means for connecting said internal-combustion engine to said driving wheel of said vehicle.

2. The propulsion apparatus according to claim 1, wherein it comprises control means for electrically and selectively connecting said storage battery to said electric motor and/or to said reversible electric machine.

3. The propulsion apparatus according to claim 2, in which said control means continuously monitor the voltage at the terminals of said storage battery and the voltage at the terminals of said reversible electric machine, when said electric motor is powered by said current supplied by said storage battery and when said electric motor is powered at least partially by said reversible electric machine, respectively.

4. The propulsion apparatus according to claim 2, in which said control means interrupt the electrical connection between said storage battery and said reversible electric machine, if said control means detect that the voltage at the terminals of said storage battery is lower than a predetermined threshold voltage value.

5. The propulsion apparatus according to claim 2, wherein it comprises circuit means which are able to transfer the voltage value detected by the control means to display means.

6. The propulsion apparatus according to claim 1, wherein it comprises polarisation means able to prevent a current directed from said reversible electric machine to said storage battery.

7. The propulsion apparatus according to claim 1, wherein it comprises movement transmission members able to mechanically connect said internal-combustion engine to said reversible electric machine.

8. The propulsion apparatus according to claim 7, wherein said movement transmission members consist of a continuous variation transmission.

9. The propulsion apparatus according to claim 1, wherein said power source comprises a photovoltaic panel which can be electrically connected to said electric motor and/or to said storage battery.

10. The propulsion apparatus according to claim 1, wherein said internal-combustion engine is a two-stroke direct-injection engine.

11. The propulsion apparatus according to claim 10, wherein said two-stroke direct-injection engine is powered by natural gas.

12. The propulsion apparatus according to claim 1, wherein said internal-combustion engine is an Otto engine or diesel engine.

13. The propulsion apparatus according to claim 1, wherein said reversible electric machine is a permanent-magnet synchronous motor able to function as an electric current generator.

14. The propulsion Propulsion apparatus according to claim 1, wherein said electric motor is incorporated inside said driving wheel.

15. A vehicle comprising:
a chassis;
a plurality of wheels able to ensure stable supporting of the vehicle on the ground;
at least one of said wheels is a driving wheel so as to allow said vehicle to move;
a bodywork able to define a passenger compartment inside which at least one passenger may be accommodated in a protected position;
a propulsion apparatus according to claim 1 any
wherein said vehicle does not have movement transmission means for connecting said internal-combustion engine to said driving wheel of said vehicle 2.

16. The vehicle according to claim 15, wherein said storage battery is housed inside a box-shaped container associated with said chassis.

17. The vehicle according to claim 15, wherein said internal-combustion engine is powered by gas, said gas being contained inside tanks.

18. The vehicle according to claim 17, wherein said tanks are arranged so as to be aligned in a predefined longitudinal direction in which the vehicle extends from the front end to the rear end with reference to the direction of forward rectilinear travel of the said vehicle.

19. The vehicle according to claim 15, wherein said driving wheel is a rear driving wheel.

20. The vehicle according to claim 15, wherein it comprises two rear driving wheels.

21. The vehicle according to claim 15, wherein it comprises four driving wheels.

22. (canceled)

23. The propulsion control method according to claim 25, wherein it comprises a step involving:
continuously monitoring the voltage at the terminals of said storage battery and the voltage at the terminals of said reversible electric machine, when said electric motor is powered by said current supplied by said storage battery and when said electric motor is powered at least partially by said reversible electric machine, respectively.

24. The propulsion control method according to claim 25, wherein it comprises a further step involving:
interrupting the electrical connection between said storage battery and said reversible electric machine, if the voltage at the terminals of said storage battery is lower than a predetermined threshold voltage value.

25. A method for controlling the propulsion of a vehicle, said method comprising the steps of:
rotationally actuating at least one driving wheel of said vehicle with an electric motor;
supplying a current from a power source comprising a storage battery to said electric motor;
operationally connecting an internal-combustion engine to a reversible electric machine;
electrically connecting said reversible electric machine to said electric motor and/or to said storage battery so as to supply said current to said electric motor or recharge said storage battery, respectively; and
permanently and kinematically disengaging said internal combustion engine from said driving wheel of said vehicle in any operating condition of said vehicle.
